(19) United States
(12) Patent Application Publication
(10) Pub. No.: US 2024/0104297 A1
(43) Pub. Date: Mar. 28, 2024

(54) ANALYSIS OF SPREADSHEET TABLE IN RESPONSE TO USER INPUT

(71) Applicant: Microsoft Technology Licensing, LLC, Redmond, WA (US)

(72) Inventors: Zhitao Hou, Beijing (CN); Haidong Zhang, Beijing (CN); Yun Wang, Saratoga, CA (US); Dongmei ZHANG, Beijing (CN); Jian-Guang Lou, Redmond, WA (US)

(21) Appl. No.: 18/263,285

(22) PCT Filed: Feb. 3, 2022
(86) PCT No.: PCT/US2022/015008

§ 371 Date: Jul. 27, 2023

(30) Foreign Application Priority Data
Feb. 10, 2021 (CN) 202110185501.1

(51) Int. Cl. G06F 40/18; G06F 40/30

(52) U.S. Cl. CPC G06F 40/18; G06F 40/30

(57) ABSTRACT

According to implementations of the present disclosure, there is proposed a solution for analyzing a data table in response to a user input. In this solution, a user input in a cell of a data table is determined. The data table comprises a plurality of cells arranged in rows and columns. An analysis operation for the data table is determined based on semantics of the data table and the user input, the analysis operation corresponding to the user input. Further, a result of the analysis operation is presented in a region of the data table related to the cell. In this way, grid characteristics of the data table can be utilized to provide the result of the analysis operation as desired by a user and simple, efficient and user-friendly data analysis can be facilitated.

### BACKGROUND

As an important means to support knowledge discovery and decision-making, data analysis has been widely used. In practical applications, people often organize data in the form of data tables for visual presentation and sharing of data. Such a data table is usually presented as a grid composed of cells, that is, has a grid interface. In addition, people might expect further mining of the data so as to obtain desired information. Some data editing or analysis tools have been developed to operate raw data tables, but this requires users to have certain analysis skills and proficient operation of various editing or analysis tools.

### SUMMARY

According to implementations of the present disclosure, there is proposed a solution for analyzing a data table in response to a user input. In this solution, a user input in a cell of a data table is determined. The data table comprises a plurality of cells arranged in rows and columns. An analysis operation for the data table is determined based on semantics of the data table and the user input, the analysis operation corresponding to the user input. Further, a result of the analysis operation is presented in a region of the data table related to the cell. In this way, the result of the user desired analysis operation can be provided by using grid characteristics of the data table, to facilitate simple, efficient and user-friendly data analysis.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a block diagram of a computing device that can implement a plurality of implementations of the present disclosure;

FIG. 2 illustrates a block diagram of a processing module in accordance with some implementations of the present disclosure;

FIG. 3A illustrates an example of a user input in accordance with some implementations of the present disclosure;

FIG. 3B illustrates another example of a user input in accordance with some implementations of the present disclosure;

FIG. 3C illustrates a further example of a user input in accordance with some implementations of the present disclosure;

FIG. 4 illustrates an example of a formal language in accordance with some implementations of the present disclosure;

FIG. 5 illustrates an example representation of the semantics of a data table in accordance with some implementations of the present disclosure;

FIG. 6A illustrates an example of an act related to an adjacent column in accordance with some implementations of the present disclosure;

FIG. 6B illustrates another example of an act related to an adjacent column in accordance with some implementations of the present disclosure;

FIG. 6C illustrates a further example of an act related to an adjacent column in accordance with some implementations of the present disclosure;

FIG. 6D illustrates still a further example of an act related to an adjacent column in accordance with some implementations of the present disclosure;

FIG. 7A illustrates an example of a scenario of data input in accordance with some implementations of the present disclosure;

FIG. 7B illustrates an example of a scenario of data transformation in accordance with some implementations of the present disclosure;

FIG. 7C illustrates an example of a scenario of data visual presentation in accordance with some implementations of the present disclosure; and

FIG. 8 illustrates a flowchart of an analysis operation method for a data table in accordance with some implementations of the present disclosure.

Throughout the drawings, the same or similar reference signs refer to the same or similar elements.

### DETAILED DESCRIPTION

The present disclosure will now be discussed with reference to several example implementations. It is to be understood these implementations are discussed only for the purpose of enabling persons skilled in the art to better understand and thus implement the present disclosure, rather than suggesting any limitations on the scope of the subject matter.

As used herein, the term “includes” and its variants are to be read as open terms that mean “includes, but is not limited to.” The term “based on” is to be read as “based at least in part on.” The term “one implementation” and “an implementation” are to be read as “at least one implementation.” The term “another implementation” is to be read as “at least one other implementation.” The terms “first,” “second,” and the like may refer to different or same objects. Other definitions, explicit and implicit, may be included below.

As used herein, the term “data table” refers to an editable table in an electronic document tool. A data table is formed by cells arranged in rows and columns. Multiple cells of the data table form a grid, and the cells are filled with content, which are also called “data items.” The data table may be organized in column-major order or row-major order. Electronic documents that provide an editable data table may include, for example, spreadsheets, text documents into which data tables may be inserted, presentation documents, etc. Many electronic document tools such as spreadsheet applications, word processing applications and presentation document applications may provide editing of the data, structure and format of data tables.

As mentioned above, the data tables are usually built in the form of grids, and such data tables have large and diverse user populations. The grid interface of such data tables is quite flexible and powerful. Nevertheless, existing solutions for users to process data tables (for example, analyzing data in the data tables) usually require the users to have certain data analysis skills and proficient use of data table editing and analysis tools.

In an existing solution, a user needs to analyze data items in a data table by using a formula. Such a solution requires the user to understand the relationship between metrics of interest and data items filled in the data table while also requires the user to master the language of formulas. Another existing solution that utilizes pivot data tables is not easy to perform complex analysis and calculation. In addition, some further existing solutions do not utilize the grid interface of the data tables. Therefore, it is desirable to provide a solution for processing a data table, which is intuitive, easy to use and can meet the requirements for complex analysis.

In view of the above, according to implementations of the present disclosure, a solution is provided for processing a data table in response to a user input, so as to solve one or more of the above and other potential problems. In the solution, a user input in a cell of a data table is determined. The data table comprises a plurality of cells arranged in rows and columns. In other words, the data table has a form of grid. An analysis operation for the data table is determined based on semantics of the data table and the user input, the analysis operation corresponding to the user input. Further, a result of the analysis operation is determined and presented in a region of the data table related to the cell. In the solution, the analysis operation corresponding to the user input may include, but not limited to, data statistics, data selection, data transformation, data input, data visual presentation and so on.

In the solution, the user desired operation for the data table is determined using rich information provided by the grid interface of the data table. The solution may support user inputs in natural language, thereby reducing the difficulty for users to learn specific languages (e.g., formulas) for data processing and analysis. Moreover, based on an effective understanding of the semantics of the data table, the solution can automatically determine the analysis operation for the data table according to the determined user input in the cell. In addition, the solution provides the result of the analysis operation directly in a region of the grid interface related to the user input. In this way, complex data analysis and processing may be easily and efficiently realized. Meanwhile, by supporting the user input in the cell of the data table and presenting the operation result in a region related to the user input, the user can conveniently and intuitively perform analysis and operations on the data table and user experience is further improved.

Various example implementations of the solution are described in detail below with reference to the drawings.

### Example Environment

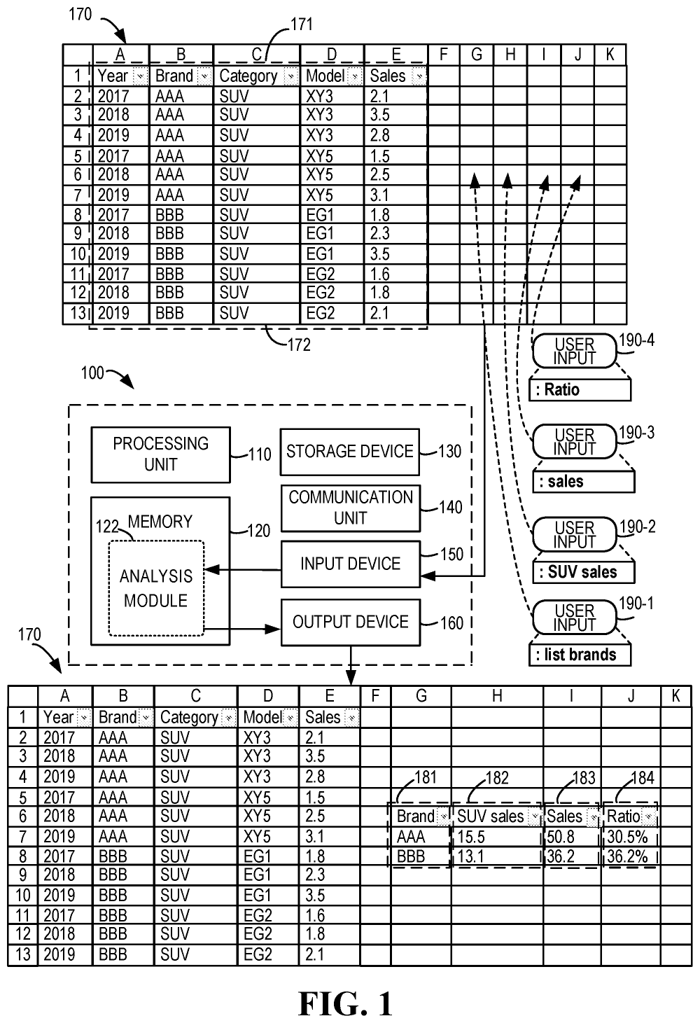

FIG. 1 illustrates a block diagram of a computing device 100 that can implement a plurality of implementations of the present disclosure. It should be understood that the computing device 100 shown in FIG. 1 is only exemplary and should not constitute any limitation on the functions and scopes of the implementations described by the present disclosure. As shown in FIG. 1, the computing device 100 includes a computing device 100 in the form of a general purpose computing device. Components of the computing device 100 may include, but is not limited to, one or more processors or processing units 110, a memory 120, a storage device 130, one or more communication units 140, one or more input devices 150, and one or more output devices 160.

In some implementations, the computing device 100 may be implemented as various user terminals or service terminals. The service terminals may be servers, large-scale computing devices, and the like provided by a variety of service providers. The user terminal, for example, is a mobile terminal, a fixed terminal or a portable terminal of any type, including a mobile phone, a site, a unit, a device, a multimedia computer, a multimedia tablet, Internet nodes, a communicator, a desktop computer, a laptop computer, a notebook computer, a netbook computer, a tablet computer, a Personal Communication System (PCS) device, a personal navigation device, a Personal Digital Assistant (PDA), an audio/video player, a digital camera/video, a positioning device, a television receiver, a radio broadcast receiver, an electronic book device, a gaming device or any other combination thereof including accessories and peripherals of these devices or any other combination thereof. It may also be predicted that the computing device 100 can support any type of user-specific interface (such as a “wearable” circuit, and the like).

The processing unit 110 may be a physical or virtual processor and may execute various processing based on the programs stored in the memory 120. In a multi-processor system, a plurality of processing units executes computer-executable instructions in parallel to enhance parallel processing capability of the computing device 100. The processing unit 110 can also be known as a central processing unit (CPU), microprocessor, controller and microcontroller.

The computing device 100 usually includes a plurality of computer storage mediums. Such mediums may be any attainable medium accessible by the computing device 100, including but not limited to, a volatile and non-volatile medium, a removable and non-removable medium. The memory 120 may be a volatile memory (e.g., a register, a cache, a Random Access Memory (RAM)), a non-volatile memory (such as, a Read-Only Memory (ROM), an Electrically Erasable Programmable Read-Only Memory (EEPROM), flash), or any combination thereof. The memory 120 may include one or more modules with one or more program instructions. These modules may be accessed and run by the processing unit 110 to realize functions of various implementations described herein. For example, the memory 120 may comprise an analysis module 122 for providing an operation result for a data table in response to a user input.

The storage device 130 may be a removable or non-removable medium, and may include a machine-readable medium (e.g., a memory, a flash drive, a magnetic disk) or any other medium, which may be used for storing information and/or data and be accessed within the computing device 100. The computing device 100 may further include additional removable/non-removable, volatile/non-volatile storage mediums. Although not shown in FIG. 1, there may be provided a disk drive for reading from or writing into a removable and non-volatile disk and an optical disc drive for reading from or writing into a removable and non-volatile optical disc. In such cases, each drive may be connected to a bus (not shown) via one or more data medium interfaces.

The communication unit 140 implements communication with another computing device via a communication medium. Additionally, functions of components of the computing device 100 may be realized by a single computing cluster or a plurality of computing machines, and these computing machines may communicate through communication connections. Therefore, the computing device 100 may operate in a networked environment using a logic connection to one or more other servers, a Personal Computer (PC) or a further general network node.

The input device 150 may be one or more various input devices, such as a mouse, a keyboard, a trackball, a voice-input device, and the like. The output device 160 may be one or more output devices, e.g., a display, a loudspeaker, a printer, and so on. The computing device 100 may also communicate through the communication unit 140 with one or more external devices (not shown) as required, where the external device, e.g., a storage device, a display device, and so on, communicates with one or more devices that enable users to interact with the computing device 100, or with any device (such as a network card, a modem, and the like) that enable the computing device 100 to communicate with one or more other computing devices. Such communication may be executed via an Input/Output (I/O) interface (not shown).

In some implementations, apart from being integrated on an individual device, some or all of the respective components of the computing device 100 may also be set in the form of a cloud computing architecture. In the cloud computing architecture, these components may be remotely arranged and may cooperate to implement the functions described by the present disclosure. In some implementations, the cloud computing provides computation, software, data access and storage services without informing a terminal user of physical locations or configurations of systems or hardware providing such services. In various implementations, the cloud computing provides services via a Wide Area Network (such as Internet) using a suitable protocol. For example, the cloud computing provider provides, via the Wide Area Network, the applications, which can be accessed through a web browser or any other computing component. Software or components of the cloud computing architecture and corresponding data may be stored on a server at a remote location. The computing resources in the cloud computing environment may be merged or spread at a remote datacenter. The cloud computing infrastructure may provide, via a shared datacenter, the services even though they are shown as a single access point for the user. Therefore, components and functions described herein can be provided using the cloud computing architecture from a service provider at a remote location. Alternatively, components and functions may also be provided from a conventional server, or they may be mounted on a client device directly or in other ways.

The computing device 100 may be used for implementing data table processing in various implementations of the present disclosure. As shown in FIG. 1, in an example, the computing device 100 may receive a data table 170 through the input device 150. In another example, the computing device 100 may retrieve from the storage device 130 the data table 170 stored therein. In a further example, the computing device 100 may receive the data table 170 from external via the communication unit 140.

In the example of FIG. 1, the data table 170 is organized in the column-major order. Columns may be represented with letters “A,” “B,” “C,” etc., and rows may be represented with Arabic numbers “1,” “2,” “3,” etc. Accordingly, cells may be represented with combinations of letters and numbers. For example, a cell 172 may be represented as “C13.”

Data items are filled in a region 171 of the data table 170, i.e., columns A to E. In this specific example, columns A to E indicate “Year,” “Brand,” “Category,” “Model” and “Sales” respectively. No data items are filled in columns F to K in the data table 170 before being processed by the analysis module 122.

The computing device 100 can receive through the input device 150 a user input to a cell in the data table 170. FIG. 1 shows user inputs 190-1, 190-2, 190-3 and 190-4 to cells G6, H6, 16 and J6 respectively, which may be referred to as “user inputs 190” collectively or an “user input 190” individually. The user input 190 may be an input in natural language. The user input 190 may be an input in natural language combined with a symbol (e.g., mathematical symbol). The user input 190 may include words and phrases. In implementations according to the present disclosure, the user input 190 may comprise an incomplete sentence. The user input 190 indicates that an operation is to be performed on the data table 170. To this end, the user input 190 may start with a predetermined symbol. Alternatively, or in addition, a specific mode may be set in an application that presents the data table 170. When the specific mode is started, an input to a cell in the data table 170 may indicate that an operation is to be performed on the data table 170.

In some implementations, the user input 190 may be an input in the textual form. For example, the user input 190 may be a natural language input starting with a predetermined symbol. The predetermined symbol may be any appropriate symbol, such as a colon, a question mark. The user may input, in a cell, a text starting with the predetermined symbol. In such an implementation, in response to detecting a user input starting with the predetermined symbol in a cell, the analysis module 122 may begin to process the data table 170 to present a result of an analysis operation as desired by the user. In this way, the user may trigger the processing of the data table in a simple and direct way.

In some implementations, the user input 190 may be a text converted from a voice input of a user. For example, the user may select a certain cell (e.g., the cell G6) of the data table 170 by using his/her finger or a stylus, and say words, phrases or sentences by using a voice input device. In such an implementation, in response to receiving a voice input to the cell, the analysis module 122 may convert the voice input to the text and then process the data table based on the text, so as to present a result of the analysis operation as desired by the user.

The data table 170 and the user input 190 are provided to the analysis module 122. By interpreting the user input 190, the analysis module 122 determines an analysis operation for the data table 170 and corresponding to the user input 190. The analysis module 122 determines a result of the analysis operation at least based on data items in the data table 170. The computing device 100 may present the result of the analysis operation in a region of the data table 170 related to the cell of the user input. For example, the computing device 100 may present the result of the analysis operation in a column to which the cell where the user input 190 is received belongs.

With reference to the example of FIG. 1, results of analysis operations corresponding to the user inputs 190-1, 190-2, 190-3 and 190-4 are presented in regions 181, 182, 183 and 184, respectively. The user inputs 190-1, 190-2, 190-3 and 190-4 may be received separately, and results of corresponding analysis operations may be presented separately. The computing device 100 may determine the user input 190-1 in cell G6, e.g., “:list brands” shown in FIG. 1. In response to the user input 190-1, the computing device 100 may present in the region 181 a result of an analysis operation corresponding to the user input 190-1, i.e., listing brands “AAA” and “BBB.” Subsequently, the computing device 100 may determine the user input 190-2 in cell H6, e.g., “:SUV sales” shown in FIG. 1. In response to the user input 190-2, the computing device 100 may present in the region 182 a result of an analysis operation corresponding to the user input 190-2, i.e., showing sales of SUV for brands “AAA” and “BBB.” Next, the computing device 100 may determine the user input 190-3 in cell 16, e.g., “: sales” shown in FIG. 1. In response to the user input 190-3, the computing device 100 may present in the region 183 a result of an analysis operation corresponding to the user input 190-3, i.e., showing total sales for brands “AAA” and “BBB.” Similarly, the computing device 100 may determine the user input 190-4 in cell J6, e.g., “: Ratio” shown in FIG. 1. In response to the user input 190-4, the computing device 100 may present in the region 184 a result of an analysis operation corresponding to the user input 190-4, i.e., showing the ratio of SUV sales to total sales for brands “AAA” and “BBB.”

If a data item filled in the data table is updated, results presented in the regions 181, 182, 183 and 184 may also be updated in time. For example, if the SUV sales of brand “AAA” in 2017 are modified, i.e., if the data item in cell E2 is modified, data items in cells H7, 17 and J7 are also updated accordingly. In another example, if sales of brand “CCC” in 2017 to 2019 are added to columns A to E in the data table 170, the following data items may be filled in cells G9, H9, 19 and J9 respectively: brand “CCC,” SUV sales for brand “CCC,” total sales for brand “CCC,” and the ratio of SUV sales to total sales for brand “CCC.”

If the user input 190 is updated, the result of the analysis operation related to the user input 190 may also be updated accordingly. For example, if the user input 190-4 is updated, the result presented in the region 184 may be updated accordingly. In another example, if the user input 190-1 is updated, results presented in the regions 181, 182, 183 and 183 also might be updated accordingly.

It should be understood that the number of user inputs and the position of a cell related to the user input shown in FIG. 1 are merely exemplary. The computing device 100 may process more or less user inputs, and cells related to different user inputs may be or not be adjacent. In addition, although FIG. 1 shows a column-major data table 170, implementations according to the present disclosure may also be applicable to a row-major data table or a data table organized in other appropriate form. When applied to a row-major data tables, acts with respect to columns as described herein may be applied to rows.

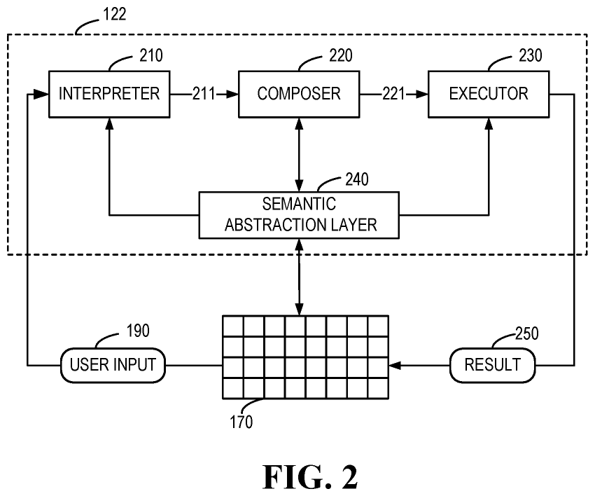

With reference to FIGS. 2 to 8, how the analysis module 122 determines the result of the analysis operation corresponding to the user input 190 will be described in detail.

### Working Principles and Basic Implementation Architecture

FIG. 2 shows an example architecture of the analysis module 122 according to some implementations of the present disclosure. As shown in FIG. 1, the analysis module 122 may be implemented in the computing device 100 of FIG. 1. For example, in some implementations, the analysis module 122 may be implemented as a computer program module. As shown in FIG. 2, the analysis module 122 generally comprises an interpreter 210, a composer 220, an executor 230 and a semantic abstraction layer 240. It should be understood that the structure and functionality of the analysis module 122 are described only for the purpose of illustration, rather than suggesting any limitation on the scope of the present disclosure. Implementations of the present disclosure may also be implemented in different structures and/or functions.

The semantic abstraction layer 240 is configured to generate and maintain semantics of the data table 170. The semantic abstraction layer 240 may generate the semantics of the data table 170 and update the semantics once the data table 170 is updated. For example, the semantic abstraction layer may generate the semantics of the data table 170 to indicate the region 171 where data items are filled as well as data items which are filled in columns A to E; after the result of the analysis operation corresponding to the user input 190-1 is presented in the region 181, the semantic abstraction layer 240 may update the semantics of the data table 170 to indicate data items which are filled in cells G6 to G8.

The semantics of the data table 170 may indicate rows and/or columns constituting the data table 170, regions where data items are filled, etc. The semantics of the data table 170 may further indicate the name, attribute, type and other information of a data item filled in the data table 170. Therefore, the semantics of the data table 170 may comprise schema information of the data table 170, which is used for describing the organization and composition of data items of the data table 170. For example, the semantics of the data table 170 may indicate that data items are organized in the column-major order, columns that form the data table 170, which column or columns are dimensions, which column or columns are measures, which column or columns are dates, etc.

In addition to the schema information, the semantics of the data table 170 may further comprise information that indicates an association between data items filled in the data table 170, which may be referred to as association information. The association information may indicate a position relationship for data items in the data table 170, for example, that two data items are filled in adjacent columns. The association information may further indicate dependencies among data items, for example, a data item in a certain column is calculated based on a data item in another column.

The semantic abstraction layer 240 may represent the extracted semantic information in any appropriate way. In some implementations, the semantic abstraction layer 240 may represent the semantics of the data table 170 with machine-readable language (such as formal language).

The interpreter 210 is configured to determine an analysis operation for the data table 170 corresponding to the user input 190 by interpreting the user input 190. Only for the purpose of illustration without any limitation to the scope of the present disclosure, the analysis operation for the data table 170 corresponding to the user input 170 is also referred to as a “target analysis operation.” The interpreter 210 may determine an act 211 to be performed by the target analysis operation based on the user input 190 and the schema information of the data table 170 as extracted by the semantic abstraction layer 240. The act 211 is also referred to as a first act.

It may be understood that the user input 190 may be converted to machine-readable language by the interpreter 210, as will be described below. In some implementations, e.g., implementations where the user input 190 is a natural language input, the interpreter 210 may be implemented as a natural language interpreter. In some implementations, e.g., implementations where the user input 190 is a voice input, the interpreter 210 may additionally have a function of speech recognition.

In some implementations, the interpreter 210 may obtain the schema information of the data table 170 from the semantic abstraction layer 240. The interpreter 210 may determine in the data table at least one correlated column matching the semantics of the user input 190, based on the schema information of the data table 170. For example, the interpreter 210 may extract a keyword from the user input 190, obtain columns forming the data table 170 from the schema information, and determine whether the extracted keyword matches the semantics of a data item in the columns. A column of which the semantics match the keyword may be determined as a correlated column. Then, the interpreter 210 may determine a first act 211 related to the at least one correlated column which is to be performed by the target analysis operation.

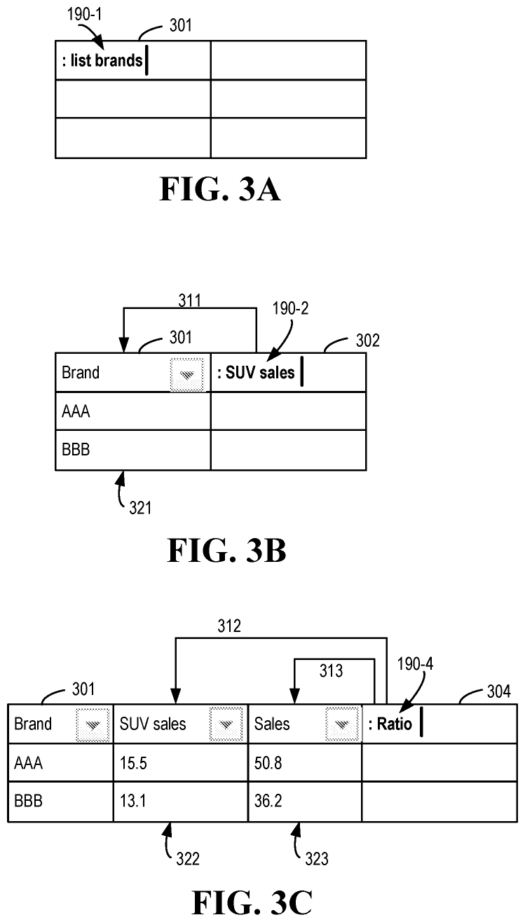

How to determine the correlated column and the first act 211 are now described with reference to examples of FIGS. 3A and 3B. The examples of FIGS. 3A and 3B correspond to the user inputs 190-1 and 190-2 shown in FIG. 1, respectively. In the examples of FIGS. 3A and 3B, the user inputs 190-1 and 190-2 are natural language inputs starting with the colon “:”. The colon “:” may be used to trigger the analysis module 122 to process the data table 170. In response to detecting the user input starting with the colon “:”, the analysis module 122 begins to process the data table 170.

Specifically, FIG. 3A shows the user input 190-1 “:list brands” to a cell 301 (i.e., cell G6 of the data table 170). The interpreter 210 may extract the noun keyword “brands” from the user input 190-1. Based on the schema information of the data table 170, the interpreter 210 may determine that the data item “Brand” filled in column B of the data table 170 matches the keyword “brands” in terms of semantics. Accordingly, the interpreter 210 may determine column B as a correlated column. The interpreter 210 may further extract the verbal keyword “list” from the user input 190-1. As such, the interpreter 210 may determine the first act 211 as listing data items filled in the correlated column B, i.e., listing values of “Brand.”

FIG. 3B shows the user input 190-2 “:SUV sales” with respect to a cell 302 (i.e., cell H6 of the data table 170). The interpreter 210 may extract the keywords “SUV” and “sales” from the user input 190-2. Based on the schema information of the data table 170, the interpreter 210 may determine that the data item “SUV” filled in column C of the data table 170 matches the extracted keyword “SUV” in terms of semantics, and the data item “sales” filled in column E of the data table 170 matches the extracted keyword “sales” in terms of semantics. Accordingly, the interpreter 210 may determine columns C and E as correlated columns. Since the keyword “SUV” is a data item filled in column C, the interpreter 210 may further determine the first act 211 as summing up data items in column E if the data item filled in column C is “SUV,” i.e., summing up “Sales” with values of “Category” being “SUV.”

In some other implementations, if the interpreter 210 does not find any correlated column matching the semantics of the user input 190 based on the schema information of the data table 170, the interpreter 210 may determine the first act 211 merely based on the first user 190. For example, the interpreter 210 may convert the user input 190 in natural language to appropriate machine-readable language to determine the first act 211.

Such implementations are described with reference to FIG. 3C. The example of FIG. 3C corresponds to the user input 190-4 shown in FIG. 1. Similar to FIGS. 3A and 3B, in the example of FIG. 3C, the user input 190-4 is also a natural language input starting with the colon “:”. FIG. 3C shows the user input 190-4 “:Ratio” to a cell 304 (i.e., cell J6 of the data table 170). The interpreter 210 may extract the keyword “Ratio” from the user input 190-4. The interpreter 210 does not find any column matching the user input 190-4 based on the schema information of the data table 170. That is, in such an implementation, the interpreter 210 does not find any correlated column matching the semantics of the user input 190-4. As such, the interpreter 210 may determine the first act 211 based on the semantics of the user input 190-4. For example, the first act 211 may be determined as calculating a ratio in the example of FIG. 3C.

Still refer to FIG. 2. The first act 211 determined by the interpreter 210 may be provided to the composer 220. The semantics of the data table 170 from the semantic abstraction layer 240 is also provided to the composer 220. The composer 220 is configured to determine the analysis operation 221 corresponding to the user input 190 based on the first act 211 and the semantics of the data table 170.

The composer 220 may determine, based on the first act 211, the target analysis operation 221 according to the association information provided by the semantic abstraction layer 240. In some implementations, the composer 220 may determine, based on the association information, at least one adjacent column adjacent to the cell to which the user input 190 is input, and determine the target analysis operation 221 based on the determined at least one adjacent column. Generally, the determined adjacent column may comprise a column which the cell of the user input 190 is closely adjacent to. In some other implementations, one or more columns within a predetermined range adjacent to the cell of the user input 190 may be determined.

In some implementations, if no data items are filled in the adjacent column, the composer 220 may determine the first act 211 as the target analysis operation 221. Reference is still made to the example of FIG. 3A where the first act 211 is determined as listing data items filled in column B. Based on the association information of the data table 170, the composer 220 may determine that no data items are filled in columns F and H which are adjacent to the cell 301 (i.e., cell G6 in FIG. 1). In this case, the composer 220 may use the first act 211 determined by the interpreter 210 as the target analysis operation 221 corresponding to the user input 190-1.

In some implementations, the composer 220 may determine an act (also referred to as a second act herein) related to the adjacent column based on the data items filled in the adjacent column. In this case, the composer 220 may determine a representation of the target analysis operation 221 corresponding to the user input 190 based on the second act.

Reference is still made to the example of FIG. 3B where the first act 211 is determined as summing up data items in column E “Sales” if the data item in column C “Category” is “SUV.” As mentioned above, after the result of the analysis operation corresponding to the user input 190-1 is presented in the region 181, the semantic abstraction layer 240 may update the semantics of the data table 170 to indicate data items filled in a column 321 (i.e., cells G6 to G8 shown in FIG. 1). As such, the composer 220 may determine the second act related to the adjacent column 321 based on the determined first act 211 and data items filled in the column 321 (i.e., column G in FIG. 1) adjacent to the cell 302. Accordingly, the composer 220 determines the representation of the target analysis operation 221 based on the second act. In the example of FIG. 3B, the target analysis operation 221 may be determined as for each data item in column G “Brand”, summing up data items in column E “Sales” with the data items in column C “Category” being “SUV”.

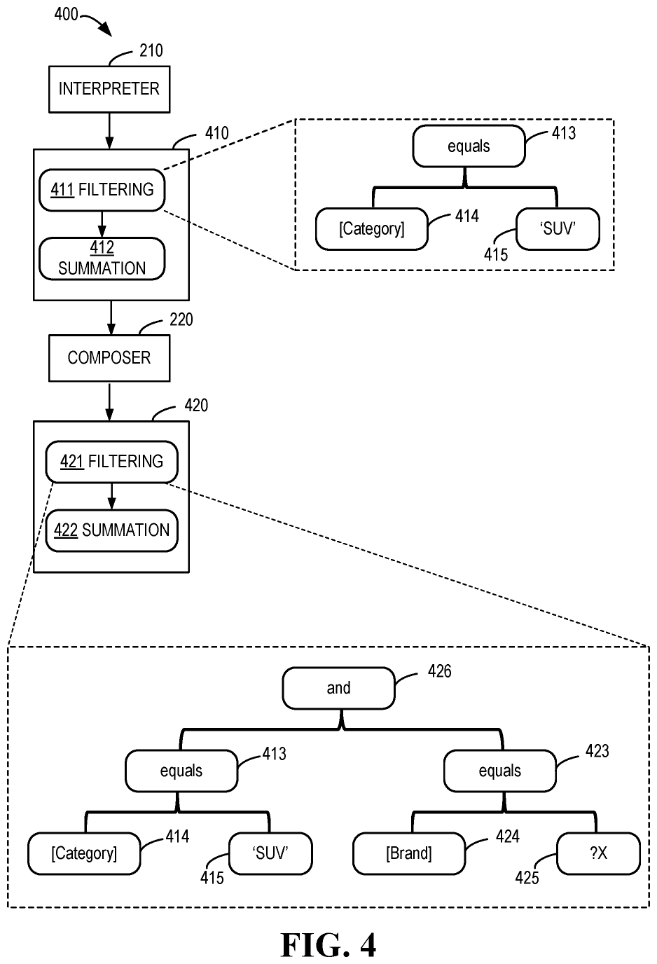

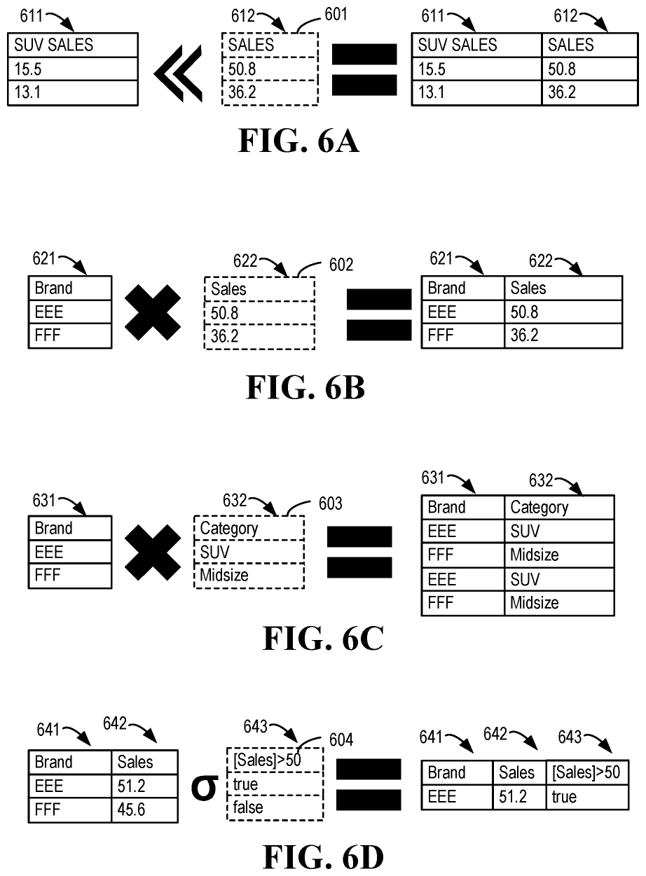

Operations of the composer 220 are briefed herein. Example operations of the composer 220 are further described with reference to FIGS. 4 and 6 below. Although the interpreter 210 and the composer 220 are shown separately in FIG. 2, it should be understood that functions above described with reference to the interpreter 210 and the composer 220 may be realized in the same module.

Any appropriate machine-readable language may be used to represent the first act 211, the second act (not shown) and the target analysis operation 221. In some implementations, structured language may be used to represent the first act 211, the second act and the target analysis operation 221. Such structured language may be structured query language (SQL).

In some implementations, logical expressions may be used to represent the first act 211, the second act and the target analysis operation 211. During processing the data table, it is desired that such logical expressions are combinable and have high-level semantic. In addition, it is also desired that such logical expressions support variables. Given that, in some implementations, Lambda analysis expressions □(□-AE) may be used to represent the first act 211, the second act and the target analysis operation 221. □-AE, as a formal language, may use a data table as an input and use a data table as an output.

Reference is now made to FIG. 4. FIG. 4 shows an example of formal language according to some implementations of the present disclosure. □-AE 410 shown in FIG. 4 may be used to represent the first act 211, and □-AE 420 may be used to represent the target analysis operation 221. As shown in FIG. 4, □-AE may be implemented as a sequence or pipeline of expression trees.

Only as an example without any limitation to the protection scope of the present disclosure, □-AE 410 and □-AE 420 shown in FIG. 4 are generated with respect to the user input 190-2 shown in FIG. 3B. As described with reference to FIG. 3B, where the user input 190-2 is “:SUV sales,” the first act 211 may be determined as summing up “Sales” with the value of “Category” being “SUV.” Accordingly, □-AE 410 consists of a sequence of an expression tree 411 for filtering and an expression tree 412 for summation. The expression tree 411 consists of nodes 413, 414 and 415 and indicates “[Category] equals ‘SUV’”, i.e., the condition for filtering data items in the data table 170 is that “Category” equals “SUV.” The expression tree 412 following the expression tree 411 may indicate summing up “Sales” in the data table 170 which has been filtered according to the expression tree 411.

As described with reference to FIG. 3B, the composer 220 determines the target analysis operation 221 as for each value in column G “Brand”, summing up “Sales” where “Category” equals “SUV”. In FIG. 4, □-AE 420 represents the target analysis operation 221. Accordingly, □-AE 420 consists of a sequence of an expression tree 421 for filtering and an expression tree 422 for summation.

As shown in FIG. 4B, as compared with the expression tree 411, the composer 220 generates the expression tree 421 by adding nodes 423, 424, 425 and 426 to the expression tree 411. The nodes 423, 424 and 425 are used to represent determining values in the adjacent column (column G in this example). The node 426 is used to represent combining each value of “Brand” with the value “SUV” of “Category.”

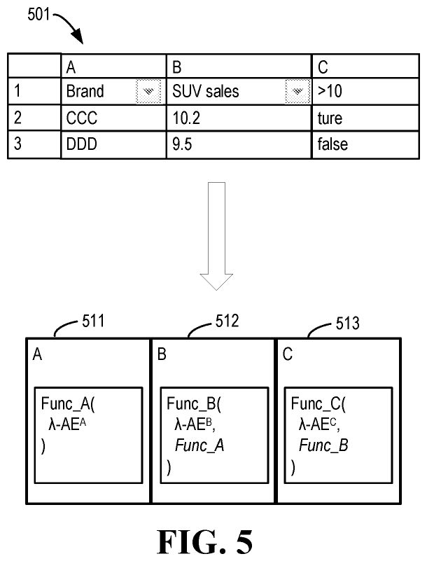

As seen from the example of FIG. 4, the sequence of the expression trees may have the □□variable as a placeholder. The □□variable “?X” represented by the node 425 may be coupled to an expression tree which may represent semantics of the adjacent column, for example, as an output of the expression tree. Regarding the example of FIG. 3B, the expression tree is related to column G and may be used to represent the semantics of column G. In this regard, further description will be presented below with reference to FIG. 5.

As seen from the above examples, □-AE is a declarative language that has high-level semantic and is combinable. Several simple □-AEs may be used to flexibly compose a complex analysis program for operating a data table. The user may indicate desired operations on the data table through natural language inputs, without a need for programming skills.

Example representations of the target analysis operation are described above with reference to FIG. 4. Referring back to FIG. 2, the target analysis operation 221 determined by the composer 220 is provided to the executor 230. For example, □-AE 420 representing the target analysis operation 221 is input to the executor 230. The executor 230 determines a result 250 of the target analysis operation corresponding to the user input 190 by performing the target analysis operation 221 on related data items in the data table 170. In some implementations, the semantic abstraction layer 240 may provide the semantics of the data table 170 to the executor 230, for obtaining related data items in the data table 170 by the executor 230.

In some implementations, the executor 230 may compile the target analysis operation 221 in machine-readable language (e.g., in the form of SQL or □-AE) into machine-executable instructions, so as to generate the result 250 based on data items in the data table 170. In some implementations, the executor 230 may be implemented as a converter, which can convert the target analysis operation 221 into a formula. The formula may be in turn executed by a document application providing the data table 170 in order to obtain the result 250. For example, if the data table 170 is provided by an EXCEL application, the executor 230 may convert the target analysis operation 221 to an EXCEL formula. Further, the result 250 of the target analysis operation may be determined based on the EXCEL formula.

After the executor 230 generates the result 250, the result 250 is presented in a region of the data table 170 which is related to the cell receiving the user input 190. For example, the result 250 may be presented in a set of cells in the same column as the cell receiving the user input 190. In the example of FIG. 1, the result of the operation corresponding to the user input 190-1 is presented in cells G7 and G8. As can be seen from FIG. 1 in conjunction with FIG. 3, the original user input “:list brands” in cell G6 is updated as “Brand” when the result of the operation is presented.

In such an implementation, the result is presented in cells which are spatially correlated to the cell of the user input. In this way, the result of the desired operation may be intuitively provided to the user, thereby improving the user experience.

If the data table 170 is updated, for example, the user updates related data items in the data table 170, the presented result 250 may be automatically updated. In some implementations, the result 250 may be automatically updated in response to updates of data items in the data table 170. After data items (e.g., data in columns A to E) in the data table 170 are updated, the executor 230 may automatically update the result 250 based on the target analysis operation 221 and the updated data table 170. Accordingly, the result 250 presented in the region of the data table 170 which is related to the cell of the user input 190 is also updated. For example, in response to brand “CCC” being added to column B of the data table 170 by the user, the executor 230 may update the result 250 and present “CCC” in cell G9.

In some implementations, the result 250 may be automatically updated in response to update of the user input 190. When the user input 190 is updated, the analysis module 122 may update the analysis operation for the data table 170 corresponding to the user input 190 and present a result of the updated analysis operation. For example, in the example of FIG. 1, after the result 250 is presented in columns G to J, the user may provide the updated user input “:list brands except BBB” in cell G6. Since operation results presented in columns H to J are related to column G, results presented in columns G to J are updated. In the updated operation results, cells G8, H8, 18 and J8 become empty. In such an implementation, the process for updating the result is similar to the process for presenting the result 250 as described with reference to FIG. 2, and thus is not detailed herein.

In some implementations, the analysis module 122 may further comprise a recommendation unit (not shown). The semantics of the data table 170 generated by the semantic abstraction layer 240 may be provided to the recommendation unit. When the user provides a user input to a cell, the recommendation unit may present potential user inputs based on words or symbols already input by the user and the semantics of the data table 170 (e.g., the schema information of the data table 170). For example, where the user inputs “:list bran,” recommended user inputs “list brands,” “list brands of SUV” and “list brands with sales>100” may be presented. The recommendation unit may generate such recommendations based on data items filled in the data table 170.

The working principle and basic implementation architecture of the data table analysis operation according to the present disclosure are described with reference to FIG. 2. Although in examples herein the data table 170 and the user input 190 are shown in English, it should be understood that this is merely exemplary and not intended to limit the protection scope of the present disclosure. The data table analysis operation according to implementations of the present disclosure is applicable to user inputs and data items in any language.

### Example Representation of Semantics of Data Table

As described with reference to FIG. 2 above, the semantic abstraction layer 240 is configured to generate and maintain the semantics of the data table 170. In other words, the semantic abstraction layer 240 implements semantic abstraction of the grid of the data table 170. In some implementations, the semantic abstraction layer 240 may represent the semantics of the data table 170 by using machine-readable language (such as formal language). Reference is now made to FIG. 5, which shows example semantic according to some implementations of the present disclosure. FIG. 5 shows formal language □-AE as an example of machine-readable language.

FIG. 5 shows an example data table 501, which comprises columns A, B and C.

Semantic 511 of column A may indicate to determine according to □-AE^{A} an output of Func_A as data items in column A. Semantic 512 of column B may indicate to determine according to □-AE^{B} an output of Func_B as data items in column B, wherein a value of a variable needed by □-AE^{B} is provided by the output of Func_A. Semantic 513 of column C may indicate to determine according to □-AE^{C} an output of Func_C as data items in column C, wherein a value of a variable needed by □-AE^{C} is provided by the output of Func_B.

In such an implementation, the association information of the data table, e.g., position relationships and dependencies between data items, may be represented in the same formal language as the first act 211 and the target analysis operation 221. In this way, the composer 220 can easily determine the target analysis operation 221 based on the association information of the data table 170 and the first act 211, e.g., can easily construct the sequence of the expression trees.

In addition, the association information of the data table 170 may be updated. For example, with reference to FIG. 1, before the user input 190-2 is received, the association information of the data table 170 may indicate that cells H6 to H8 are empty. Subsequently, the computing device 100 receives the user input 190-2 and presents a result of a corresponding operation in cells H6 to H8. Accordingly, the composer 220 may provide to the semantic abstraction layer 240 □-AE of the analysis operation corresponding to the user input 190-2. The semantic abstraction layer 240 generates semantics of cells H6 to H8 based on the □-AE, so as to update the association information of the data table 170.

### Example Operation of Composer

As described above with reference to FIG. 2, the composer 220 may use the at least one adjacent column adjacent to the cell (also referred to as the “considered cell”) of the user input 190 to determine the target analysis operation 221. For example, the composer 220 may determine the context of the analysis operation corresponding to the user input 190 based on the semantics of the at least one adjacent column. It is to be understood that the context described herein is determined using the position relationship of the cells in the data table 170, and thus such context may also be referred to as “spatial context.”

In some implementations, the context may be determined using the adjacent column closely adjacent to the considered cell. For example, in the example of FIG. 3B, as shown by an arrow 311, the column 321 closely adjacent to the considered cell 302 may be used to determine the context. As such, in conjunction with the user input 190-2 “:SUV sales,” the determined context may be that the target analysis operation sums up SUV sales with respect to the value of each data item of the adjacent column 321 (i.e., Brand).

In some implementations, the context may be determined using a plurality of columns adjacent to the considered cell. For example, in the example of FIG. 3C, the column 323 closely adjacent to the cell 304 and the column 322 (i.e., columns H and I) adjacent to the column 323 represent the same type of metrics, i.e., sales in this example. As shown by arrows 312 and 314, the columns 323 and 324 may be used to determine the context. As such, in conjunction with the user input 190-4 “:Ratio,” the determined context may be that the target analysis operation calculates the ratio of SUV sales to total sales based on the adjacent columns 322 and 323.

To this end, an operator may be defined to represent an act to be performed by the analysis operation on the data table 170, and an operand may be defined to represent a column to which the act is directed.

FIGS. 6A to 6D show examples of acts according to some implementations of the present disclosure. FIG. 6A shows an example of an append act denoted by “<<.” In the example of FIG. 6A, a column 611 is an adjacent column used to determine context. In response to a user input to a cell 601, the result of the target analysis operation will be presented in a column 612 denoted by dashed lines. In this example, the composer 220 determines that the act related to the adjacent column is to append the column 612 to the column 611.

FIG. 6B shows an example of a cross act denoted by “X.” In the example of FIG. 6B, a column 621 is an adjacent column used to determine context. In response to a user input to a cell 602, the result of the target analysis operation will be presented in a column 622 denoted by dashed lines. In this example, the composer 220 determines that the act related to the adjacent column is to cross the columns 621 and 622. As such, sales of products with the brand “EEE” and sales of products with the brand “FFF” are presented in the column 622.

FIG. 6C shows another example of the cross act denoted by “X.” In the example of FIG. 6C, a column 631 is an adjacent column used to determine context. In response to a user input to a cell 603, the result of the target analysis operation will be presented in a column 632 denoted by dashed lines. In this example, the composer 220 determines that the act related to the adjacent column is to cross the columns 631 and 632. Since values of “Category” comprise “SUV” and “Midsize,” categories “SUV” and “Midsize” are presented in the column 632 with respect to brands “EEE” and “FFF”, respectively.

FIG. 6D shows an example of a filter act denoted by “D.” In the example of FIG. 6D, columns 641 and 642 are adjacent columns used to determine context. In response to a user input to a cell 604, the result of the target analysis operation will be presented in a column 643 denoted by dashed lines. In this example, the composer 220 determines that the act related to the adjacent columns is to perform a filter act on the columns 641 and 642, i.e., keeping the rows where the value of “Sales” is greater than 50. As such, related data for the brand “EEE” is presented in the updated data table only.

As seen from the above description, the composer 220 may determine the context of the analysis operation corresponding to the user input 190 based on the at least one adjacent column. Therefore, the composer 220 may be implemented based on the context-aware algebra, and such calculation comprises the defined operands and operators.

It should be understood that the acts related to the adjacent column as above described with reference to FIGS. 6A to 6D are merely exemplary and not intended to limit the scope of the present disclosure. Various acts performed by the composer 220 may be defined. The composer 220 may use heuristics to select to-be-performed acts related to the adjacent column from the above described acts and other possible acts.

### Example Scenario

As mentioned above, the analysis operation for the data table corresponding to the user input may comprise data statistics, data input, data transformation and data visual presentation. The data table processing according to the present disclosure has been described above mainly in conjunction with the scenario of data statistics. The data table analysis operation proposed herein may be applicable to other scenarios, including but not limited to, a scenario of data input, a scenario of data transformation and a scenario of data visual presentation.

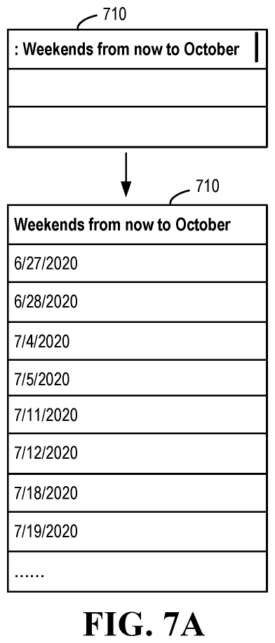

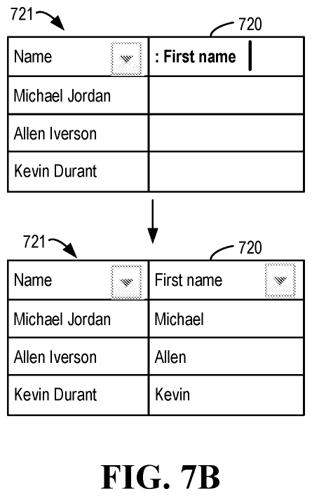

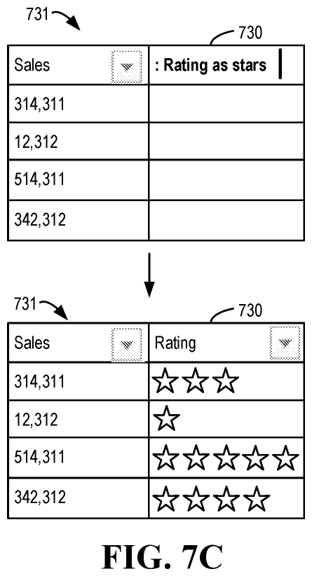

FIG. 7A shows an example of the scenario of data input according to some implementations of the present disclosure. FIG. 7A shows a user input “:Weekends from now to October” to a cell 710. The computing device 100 may determine an analysis operation corresponding to the user input as data input, i.e., listing all weekends from now to October. Then, the computing device 100 may determine a result of the operation based on a system calendar or other data source, and present the determined dates in a set of cells below the cell 710.

FIG. 7B shows an example of the scenario of data transformation according to some implementations of the present disclosure. As shown, “Names” such as “Michael Jordan,” “Allen Iverson” and “Kevin Durant” are presented in a column 721. A user input to a cell 720 is “:First name.” The computing device 100 may determine an analysis operation corresponding to the user input as data transformation, i.e., converting each name in the column 721 to the “first name.” Accordingly, the computing device 100 may present “First names” such as “Michael,” “Allen,” and “Kevin” in cells below the cell 720.

FIG. 7C shows an example of the scenario of data visual presentation according to some implementations of the present disclosure. As shown, “Sales” are presented in a column 731. A user input to a cell 730 is “:rating as stars.” The computing device 100 may determine an analysis operation corresponding to the user input as data visual presentation, i.e., presenting ratings with stars according to values of “Sales.” Accordingly, the computing device 100 may present patterns with a corresponding number of stars in cells below the cell 730 as “Rating.”

### Example Method and Example Implementation

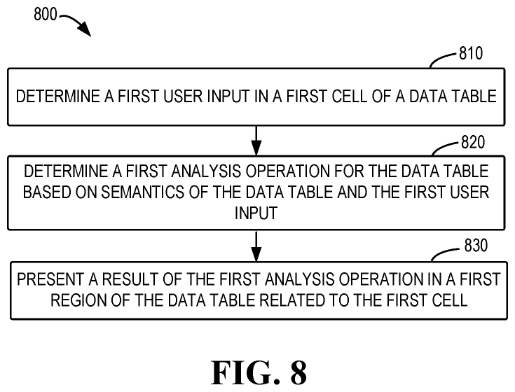

FIG. 8 shows a flowchart of a method 800 for processing a data table according to some implementations of the present disclosure. The method 800 may be implemented by the computing device 100, e.g., implemented at the data table analysis module 122 in the memory 120 of the computing device 100.

As shown in FIG. 8, at block 810, the computing device 100 determines a first user input (e.g., any of the user inputs 190-1 to 190-4) in a first cell of a data table. The data table comprises a plurality of cells arranged in rows and columns. In some implementations, the first user input is a natural language input starting with a predetermined symbol.

At block 820, the computing device 100 determines a first analysis operation for the data table based on semantics of the data table and the first user input, the first analysis operation corresponding to the first user input.

In some implementations, determining the first analysis operation comprises: determining in the data table at least one correlated column matching semantics of the first user input and at least one adjacent column adjacent to the first cell, based on semantics of the data table; and determining the first analysis operation based on the at least one correlated column matching the semantics of the first user input and the at least one adjacent column adjacent to the first cell.

In some implementations, determining the first analysis operation comprises: determining a first act related to the at least one correlated column based on data items filled in the at least one correlated column; determining a second act related to the at least one adjacent column based on the first act and data items filled in the at least one adjacent column; and determining a representation of the first analysis operation based on the second act.

At block 830, the computing device 100 presents a result of the first analysis operation in a first region of the data table related to the first cell.

In some implementations, presenting a result of the first analysis operation in the first region comprises: determining the result of the first analysis operation based on at least one portion of a plurality of data items in the plurality of cells; and presenting the result of the first analysis operation in a set of cells in the same column as the first cell.

In some implementations, the method 800 further comprises: determining a second user input in a second cell of the data table, the second cell adjacent to the first cell, and the second user input indicating that an operation is to be performed on the data table; determining a second analysis operation for the data table based on the second user input, semantics of the data table and the result of the first analysis operation, the second analysis operation corresponding to the second user input; and presenting a result of the second analysis operation in a second region of the data table related to the second cell. For example, the first user input may be the user input 190-1, the second user input may be the user input 190-2. In another example, the first user input may be the user input 190-2, and the second user input may be the user input 190-3.

In some implementations, the method 800 further comprises: in accordance with a determination that the first user input is updated, updating the result of the first analysis operation presented in the first region; and updating the result of the second analysis operation presented in the second region based on the updated result of the first analysis operation.

Some example implementations of the present disclosure are listed below.

In one aspect, the present disclosure provides a computer-implemented method. The method comprises: determining a first user input in a first cell of a data table, the data table comprising a plurality of cells arranged in rows and columns, and the first user input indicating that an operation is to be performed on the data table; determining a first analysis operation for the data table based on semantics of the data table and the first user input, the first analysis operation corresponding to the first user input; and presenting a result of the first analysis operation in a first region of the data table related to the first cell.

In some implementations, determining the first analysis operation comprises: determining in the data table at least one correlated column matching semantics of the first user input and at least one adjacent column adjacent to the first cell, based on semantics of the data table; and determining the first analysis operation based on the at least one correlated column matching the semantics of the first user input and the at least one adjacent column adjacent to the first cell.

In some implementations, determining the first analysis operation comprises: determining a first act related to the at least one correlated column based on data items filled in the at least one correlated column; determining a second act related to the at least one adjacent column based on the first act and data items filled in the at least one adjacent column; and determining a representation of the first analysis operation based on the second act.

In some implementations, the method further comprises: determining a second user input in a second cell of the data table, the second cell adjacent to the first cell, and the second user input indicating that an operation is to be performed on the data table; determining a second analysis operation for the data table based on the second user input, semantics of the data table and the result of the first analysis operation, the second analysis operation corresponding to the second user input; and presenting a result of the second analysis operation in a second region of the data table related to the second cell.

In some implementations, the method further comprises: in accordance with a determination that the first user input is updated, updating the result of the first analysis operation presented in the first region; and updating the result of the second analysis operation presented in the second region based on the updated result of the first analysis operation.

In some implementations, the first user input is a natural language input starting with a predetermined symbol.

In some implementations, presenting the result of the first analysis operation in the first region comprises: determining the result of the first analysis operation based on at least one portion of a plurality of data items in the plurality of cells; and presenting the result of the first analysis operation in a set of cells in the same column as the first cell.

In another aspect, the present disclosure provides an electronic device. The electronic device comprises: a processing unit; and a memory coupled to the processing unit and comprising instructions stored thereon which, when executed by the processing unit, cause the device to perform acts comprising: determining a first user input in a first cell of a data table, the data table comprising a plurality of cells arranged in rows and columns, and the first user input indicating that an operation is to be performed on the data table; determining a first analysis operation for the data table based on semantics of the data table and the first user input, the first analysis operation corresponding to the first user input; and presenting a result of the first analysis operation in a first region of the data table related to the first cell.

In some implementations, determining the first analysis operation comprises: determining in the data table at least one correlated column matching semantics of the first user input and at least one adjacent column adjacent to the first cell, based on semantics of the data table; and determining the first analysis operation based on the at least one correlated column matching the semantics of the first user input and the at least one adjacent column adjacent to the first cell.

In some implementations, determining the first analysis operation comprises: determining a first act related to the at least one correlated column based on data items filled in the at least one correlated column; determining a second act related to the at least one adjacent column based on the first act and data items filled in the at least one adjacent column; and determining a representation of the first analysis operation based on the second act.

In some implementations, the acts further comprise: determining a second user input in a second cell of the data table, the second cell adjacent to the first cell, and the second user input indicating that an operation is to be performed on the data table; determining a second analysis operation for the data table based on the second user input, semantics of the data table and the result of the first analysis operation, the second analysis operation corresponding to the second user input; and presenting a result of the second analysis operation in a second region of the data table related to the second cell.

In some implementations, the acts further comprise: in accordance with a determination that the first user input is updated, updating the result of the first analysis operation presented in the second region; and updating the result of the second analysis operation presented in the second region based on the updated result of the first analysis operation.

In some implementations, the first user input is a natural language input starting with a predetermined symbol.

In some implementations, presenting the result of the first analysis operation in the first region comprises: determining the result of the first analysis operation based on at least one portion of a plurality of data items in the plurality of cells; and presenting the result of the first analysis operation in a set of cells in the same column as the first cell.

In a further aspect, the present disclosure provides a computer program product being tangibly stored in a non-transitory computer storage medium and comprising machine-executable instructions which, when executed by a device, causing the device to perform the method of the above aspect.

In still a further aspect, the present disclosure provides a computer-readable medium having machine-executable instructions stored thereon which, when executed by a device, cause the device to perform the method of the above aspect.

The functionality described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-chip systems (SOCs), Complex Programmable Logic Devices (CPLDs), and the like.

Program code for carrying out methods of the present disclosure may be written in any combination of one or more programming languages. These program codes may be provided to a processor or controller of a general purpose computer, a special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or a server.

In the context of this present disclosure, a machine-readable medium may be any tangible medium that may contain, or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, it should be understood that the operations are required to be executed in the particular order shown or in a sequential order, or all operations shown are required to be executed to achieve the expected results. In certain circumstances, multitasking and parallel processing may be advantageous. Likewise, while several specific implementation details are contained in the above discussions, these should not be construed as limitations on the scope of the present disclosure. Certain features that are described in the context of separate implementations may also be implemented in combination in a single implementation. Conversely, various features that are described in the context of a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

1. A computer-implemented method, comprising:
determining a first user input in a first cell of a data table, the data table comprising a plurality of cells arranged in rows and columns, and the first user input indicating that an operation is to be performed on the data table;
determining a first analysis operation for the data table based on semantics of the data table and the first user input, the first analysis operation corresponding to the first user input; and
presenting a result of the first analysis operation in a first region of the data table related to the first cell.

2. The method of claim 1, wherein determining the first analysis operation comprises:
determining in the data table at least one correlated column matching semantics of the first user input and at least one adjacent column adjacent to the first cell, based on semantics of the data table; and
determining the first analysis operation based on the at least one correlated column matching the semantics of the first user input and the at least one adjacent column adjacent to the first cell.

3. The method of claim 2, wherein determining the first analysis operation comprises:
determining a first act related to the at least one correlated column based on data items filled in the at least one correlated column;
determining a second act related to the at least one adjacent column based on the first act and data items filled in the at least one adjacent column; and
determining a representation of the first analysis operation based on the second act.

4. The method of claim 1, further comprising:
determining a second user input in a second cell of the data table, the second cell adjacent to the first cell, and the second user input indicating that an operation is to be performed on the data table;
determining a second analysis operation for the data table based on the second user input, semantics of the data table and the result of the first analysis operation, the second analysis operation corresponding to the second user input; and
presenting a result of the second analysis operation in a second region of the data table related to the second cell.

5. The method of claim 4, further comprising:
in accordance with a determination that the first user input is updated, updating the result of the first analysis operation presented in the first region; and
updating the result of the second analysis operation presented in the second region based on the updated result of the first analysis operation.

6. The method of claim 1, wherein the first user input is a natural language input starting with a predetermined symbol.

7. The method of claim 1, wherein presenting the result of the first analysis operation in the first region comprises:
determining the result of the first analysis operation based on at least one portion of a plurality of data items in the plurality of cells; and
presenting the result of the first analysis operation in a set of cells in the same column as the first cell.

8. An electronic device, comprising:
a processing unit; and
a memory coupled to the processing unit and comprising instructions stored thereon which, when executed by the processing unit, cause the device to perform acts comprising:
determining a first user input in a first cell of a data table, the data table comprising a plurality of cells arranged in rows and columns, and the first user input indicating that an operation is to be performed on the data table;
determining a first analysis operation for the data table based on semantics of the data table and the first user input, the first analysis operation corresponding to the first user input; and
presenting a result of the first analysis operation in a first region of the data table related to the first cell.

9. The device of claim 8, wherein determining the first analysis operation comprises:
determining in the data table at least one correlated column matching semantics of the first user input and at least one adjacent column adjacent to the first cell, based on semantics of the data table; and
determining the first analysis operation based on the at least one correlated column matching the semantics of the first user input and the at least one adjacent column adjacent to the first cell.

10. The device of claim 9, wherein determining the first analysis operation comprises:
determining a first act related to the at least one correlated column based on data items filled in the at least one correlated column;
determining a second act related to the at least one adjacent column based on the first act and data items filled in the at least one adjacent column; and
determining a representation of the first analysis operation based on the second act.

11. The device of claim 8, the acts further comprising:
determining a second user input in a second cell of the data table, the second cell adjacent to the first cell, and the second user input indicating that an operation is to be performed on the data table;
determining a second analysis operation for the data table based on the second user input, semantics of the data table and the result of the first analysis operation, the second analysis operation corresponding to the second user input; and
presenting a result of the second analysis operation in a second region of the data table related to the second cell.

12. The device of claim 11, the acts further comprising:
in accordance with a determination that the first user input is updated, updating the result of the first analysis operation presented in the first region; and
updating the result of the second analysis operation presented in the second region based on the updated result of the first analysis operation.

13. The device of claim 8, wherein the first user input is a natural language input starting with a predetermined symbol.

14. The device of claim 8, wherein presenting the result of the first analysis operation in the first region comprises:
determining the result of the first analysis operation based on at least one portion of a plurality of data items in the plurality of cells; and
presenting the result of the first analysis operation in a set of cells in the same column as the first cell.

15. A computer program product, comprising machine-executable instructions which, when executed by a device, cause the device to perform acts comprising:
determining a first user input in a first cell of a data table, the data table comprising a plurality of cells arranged in rows and columns, and the first user input indicating that an operation is to be performed on the data table;
determining a first analysis operation for the data table based on semantics of the data table and the first user input, the first analysis operation corresponding to the first user input; and
presenting a result of the first analysis operation in a first region of the data table related to the first cell.
